(19) United States
(12) Patent Application Publication
(10) Pub. No.: US 2014/0201105 A1
(43) Pub. Date: Jul. 17, 2014

(54) INVESTMENT PORTFOLIO RISK ANALYSIS SYSTEM

(71) Applicant: PrairieSmarts LLC, Omaha, NE (US)

(72) Inventors: Renaud Piccinini, Omaha, NE (US); Casey T. Rockwell, Arlington, TX (US)

(73) Assignee: PrairieSmarts LLC, Omaha, NE (US)

(21) Appl. No.: 14/155,419

(22) Filed: Jan. 15, 2014

Related U.S. Application Data
(60) Provisional application No. 61/752,496, filed on Jan. 15, 2013.

(51) Int. Cl. G06Q 40/06

(52) U.S. Cl. CPC G06Q 40/06
USPC 705/36 R

(57) ABSTRACT

A computer-implemented method includes receiving information identifying an investment; receiving information associated with a financial characteristic of the investment; and causing a processor to determine one or more of a range of motion, a portfolio history, an economic value of the tail, an exposure, and points of ruin associated with the investment using the financial characteristic of the investment. The processor can also initiate an alert when one or more conditions are met for the investment based upon the determination of the range of motion, the portfolio history, the economic value of the tail, the exposure, and/or the points of ruin.

### CROSS-REFERENCE TO RELATED APPLICATIONS

The present application claims the benefit under 35 U.S.C. §119(e) of U.S. Provisional Application Ser. No. 61/752,496, filed Jan. 15, 2013, and titled “INVESTMENT PORTFOLIO ANALYSIS SYSTEM,” which is herein incorporated by reference in its entirety.

### BACKGROUND

The term financial instrument is typically used to refer to tradable assets of various kinds, such as cash, evidence of an ownership interest in an entity, a contractual right to receive or deliver cash or another financial instrument, and so forth. For example, cash instruments are generally financial instruments whose value is determined by a financial market. Cash instruments include securities, currencies, loans, deposits, and so forth. Derivative instruments are generally financial instruments which derive their value from the value and characteristics of one or more underlying entities, such as an asset, index, or interest rate. Derivative instruments include exchange-traded derivatives and over-the-counter (OTC) derivatives. The term capital stock or stock is typically used to refer to the equity stake of the owners of an incorporated business. Stocks include common stock, preferred stock, and so forth. The term option generally refers to a contract giving the owner the right, but not the obligation, to buy or sell an underlying asset or instrument at a specified strike price on or before a specified date.

### SUMMARY

A computer-implemented method includes receiving information identifying an investment; receiving information associated with a financial characteristic of the investment; and causing a processor to determine one or more of a range of motion, a portfolio history, an economic value of the tail, an exposure, and points of ruin associated with the investment using the financial characteristic of the investment. The processor can also initiate an alert when one or more conditions are met for the investment based upon the determination of the range of motion, the portfolio history, the economic value of the tail, the exposure, and/or the points of ruin.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is a block diagram illustrating a portfolio analysis system implementing a range of motion module, a portfolio history determination module, an economic value of the tail module, an exposure determination module, a points of ruin module, and an alert module in accordance with example embodiments of the present disclosure.

FIG. 2 is a block diagram illustrating a portfolio analysis system connected to a client device via a network in accordance with example embodiments of the present disclosure.

FIG. 3 is a block diagram illustrating a portfolio analysis system architecture including a user interface layer, a data layer, and a calculation layer in accordance with example embodiments of the present disclosure.

FIG. 4 is a flow diagram illustrating a process for determining one or more of a range of motion, a portfolio history, an economic value of the tail, an exposure, and a point of ruin associated with an investment using a financial characteristic of the investment.

### DETAILED DESCRIPTION

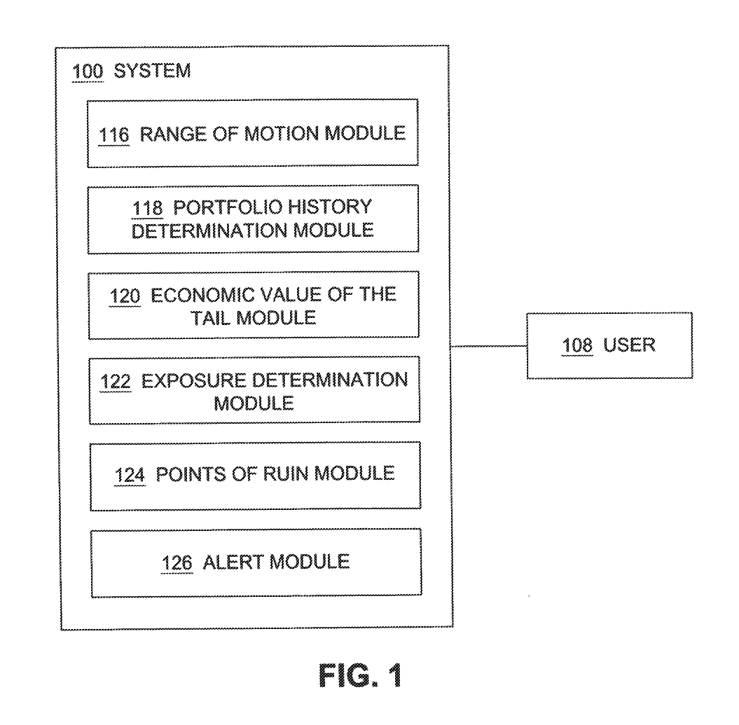

Referring generally to FIGS. 1 through 3, a system 100 is described. The system 100 is configured to connect to a network 102 and provide one or more client devices 104 with a user interface 106. The user interface 106 is configured to provide analysis of a portfolio of investments, such as stocks, securities, derivatives, options, and so forth, to a user 108. In some embodiments, analysis is provided by system 100 in the form of a predetermined report supplied to a user 108 via the user interface 106. In other embodiments, analysis is provided by system 100 dynamically. For example, a system 100 can determine information associated with a user-specified portfolio of investments and provide the information to a user 108 dynamically (e.g., so that the user 108 can alter characteristics of the portfolio and observe results provided by the system 100 via the user interface 106 on-the-fly). In further embodiments, an alert is provided to a user 108. In some embodiments, information associated with a portfolio of investments is provided without significant time delays. For instance, the system 100 provides information in real-time or near real-time (NRT) (e.g., where any time delays are contributed by automated data processing and/or network transmission delays).

A client device 104 can be an information handling system device, including but not necessarily limited to: a mobile computing device (e.g., a hand-held portable computer, a personal digital assistant (PDA), a laptop computer, a netbook computer, a tablet computer, and so forth), a mobile telephone device (e.g., a cellular telephone, a smartphone), a device that includes functionalities associated with smartphones and tablet computers (e.g., a phablet), a portable game device, a portable media player device, a multimedia device, an e-book reader device (eReader), a smart television (TV) device, a surface computing device (e.g., a table top computer), a personal computer (PC) device, and so forth. One or more client devices 104 can be associated with a user. A user 108 can communicate with the system 100 via a client device 104.

In some embodiments, a system 100 provides on demand software, e.g., in the manner of software as a service (SaaS) distributed to a client device 104 via the network 102 (e.g., the Internet). For example, a system 100 hosts portfolio analysis software and associated data in the cloud. The software is accessed by the client device 104 with a thin client (e.g., via a web browser 110). A user 108 interfaces with the software (e.g., a web page 112) provided by the system 100 via the user interface 106 (e.g., using web browser 110). In embodiments of the disclosure, the system 100 communicates with a client device 104 using an application protocol, such as hypertext transfer protocol (HTTP). In some embodiments, the system 100 provides a client device 104 with a user interface 106 accessed using a web browser 110 and displayed on a monitor and/or a mobile device. Web browser form input can be provided using a hypertext markup language (HTML) and/or extensible HTML (XHTML) format, and can provide navigation to other web pages (e.g., via hypertext links). The web browser 110 can also use other resources such as style sheets, scripts, images, and so forth.

In other embodiments, content is served to a client device 104 using another application protocol. For instance, a third-party tool provider 114 (e.g., a tool provider not operated and/or maintained by a system 100) can include content from a system 100 (e.g., embedded in a web page 112 provided by the third-party tool provider 114). It should be noted that a thin client configuration for the client device 104 is provided by way of example only and is not meant to limit the present disclosure. In other embodiments, the client device 104 is implemented as a thicker (e.g., fat, heavy, rich) client. For example, the client device 104 provides rich functionality independently from the system 100. In some embodiments, one or more cryptographic protocols are used to transmit information between a system 100 and a client device 104 and/or a third-party tool provider 114. Examples of such cryptographic protocols include, but are not necessarily limited to: a transport layer security (TLS) protocol, a secure sockets layer (SSL) protocol, and so forth. For instance, communications between a system 100 and a client device 104 can use HTTP secure (HTTPS) protocol, where HTTP protocol is layered on SSL and/or TLS protocol.

The system 100 includes a range of motion module 116, which can be used to provide a range of motion (ROM) for an investment such as, but not necessarily limited to, a security. In embodiments, the system 100 implements a range of motion model where F(X) is equal to a one-period log-return cumulative probability distribution (cdf) of X, and ƒ(X) is a probability density function (pdf) of X. The distribution is defined by three parameters: a mean (μ) and two dispersion parameters (λ and ρ). The cdf is determined as follows:

$$F ( X ) = \frac{1}{λ \sqrt{2 π}} {\int }_{0}^{∞} \frac{1}{y} {e}^{- \frac{{ln ( y / ρ )}^{2}}{2 * {λ}^{2}}} Φ ( \frac{x - μ}{\sqrt{2} y} ) d y$$

where Φ(x) represents the standard normal distribution cdf. The pdf is determined as follows:

$$f ( X ) = {\int }_{0}^{∞} \frac{{e}^{- \frac{{( x - μ )}^{2}}{4 {y}^{2}} - \frac{{ln ( y / ρ )}^{2}}{2 {λ}^{2}}}}{2 {y}^{2} \sqrt{π}} d y$$

Further, Q(α)=F⁻¹(X) represents the quantile function of X For parameter estimation, where X(n) is a vector time series of n one-period log-returns for a particular financial security, the parameters μ, λ, and ρ of the distribution of X(n) are estimated as follows:

$$\hat{μ} = Mean [ X ( n ) ] = \frac{1}{n} \sum X ( n )$$

$$\hat{ρ} = \frac{exp ( Mean [ ln ( \vert X ( n ) - \hat{μ} \vert ) ] - \frac{{Γ}^{′} ( 1 )}{2 Γ ( 1 )} )}{1 + 9.30059 {n}^{- 0.4620632}}$$

$$\hat{λ} = \sqrt{2 ln ( Mean [ \vert X ( n ) - \hat{μ} \vert ] ) - ln ( \frac{2}{\sqrt{π}} ) - ln ( Mean [ ln ( \vert X ( n ) - \hat{μ} \vert ) ] - \frac{{Γ}^{′} ( 1 )}{2 Γ ( 1 )} )} + ( 5.3451494 {n}^{- 0.4620632} )$$

where Γ(x) represents the regular gamma function.

For a confidence interval α, RU(α) denotes the upper bound of the range of motion, and RD(α) denotes the lower bound of the range of motion. In embodiments, ƒ(X) denotes the pdf function of time series X(n) with estimated parameters (μ, λ, and ρ) as described above. Then, for a particular security, estimates for the range of motion are determined as follows:

$$RU ( α ) = \frac{1}{α} {\int }_{Q ( α )}^{∞} xf ( x ) d x$$

$$RD ( α ) = \frac{1}{α} {\int }_{- ∞}^{Q ( 1 - α )} xf ( x ) d x$$

where Q(α) represents the quantile function of X.

The system 100 includes a portfolio history determination module 118, which can be used to provide a portfolio history for a number of investments such as, but not necessarily limited to, financial securities and margin balance. In embodiments, the system 100 implements a portfolio history determination model where P is a portfolio composed of financial securities (denoted S) and derivatives and/or options (denoted D). In this model, each security, derivative, and option in a portfolio has a weight (denoted W). Weights for each holding in the portfolio are determined by dividing the value of the position by the equity value of the account. Then, a vector time series H(n) of the synthetic k-period log-returns of the portfolio is determined based upon the historical prices of the securities S in the portfolio and the historical prices of the underlying securities of the derivatives and/or options D in the portfolio.

For one or more securities S in the portfolio, a vector Rs is determined by multiplying the vector of k-period simple returns by a holding weight. For one or more options in the portfolio, the vector of theoretical option prices for each date is determined using the price of the underlying security for that particular date, while using the same moneyness, time to maturity, implied volatility, interest rate, and/or dividend rate as of the most recent value. This vector is denoted P(t). Then, for each date in the time series vector, theoretical option prices k-periods ahead are determined using the corresponding underlying prices (i.e., k-periods ahead) and decreasing the time-to-maturity by k-periods. This vector is denoted by P(t+k). For each date, the synthetic simple option return is determined by R=(P(t+k)−P(t))/P(t). The vector R obtained for each option is multiplied by its portfolio weight to obtain Rd. A portfolio returns series is determined by summing the weighted returns series (Rs+Rd) for all securities and derivatives. The weighted returns series can be used to determine simple return series for the portfolio, e.g., using transformed in log-returns to yield a final output.

The system 100 includes an economic value of the tail module 120, which can be used to provide a representation of the economic cost of holding a security through its worse τ periods. In embodiments, the system 100 implements an economic value of the tail model where X(n) is a vector time series of n one-period log-returns for a particular financial security. In embodiments, Y represents the sum of the lowest τ observations of X(n). The economic value of the tail (EVT) is determined as follows:

EVT=100×(e^{ΣX(n)-Y}−e^{ΣX(n)})

The system 100 includes an exposure determination module 122, which can be used to provide an exposure for a group of related holdings, such as a group of directly related holding (GDRH). Related holdings can include, but are not necessarily limited to: securities and/or one or more derivatives of an underlying security. For each GDRH in a portfolio of a current market price Pr, the system 100 determines an exposure by dividing the line between Pr·exp(RD(α)) and Pr·exp(RU(α)) into δ equally-spaced prices (e.g., δ=100), where the resulting price vector is denoted as A. For each price point in vector A, a theoretical profit/loss for the group of directly related holdings can be determined assuming no change in the current implied volatilities. For each price point in vector A, a theoretical profit/loss for the group of directly related holdings can also be determined where each implied volatility is multiplied by a factor (1+ν). For each price point in vector A, a theoretical profit/loss for the group of directly related holdings can be determined where each implied volatility is multiplied by a factor (1−νv). The greatest loss from one or more of the determinations above is defined as the “loss exposure” of the GDRH, and the greatest gain from the determinations above is defined as the “gain exposure.”

The system 100 includes a points of ruin module 124, which can be used to provide points of ruin for a portfolio of investments. In embodiments, the system 100 implements a points of ruin model where points of ruin (PoR) are a measure of single-name concentration in a portfolio. For a user-defined risk tolerance level, referred to as an “acceptable loss,” a point of ruin is defined at the group of directly related holdings (GDRH) level. The point of ruin is the closest price point from the current price, which, if reached, would cause a theoretical loss greater than or equal to the acceptable loss level. For each GDRH, there may be zero, one, or two points of ruin. In embodiments, points of ruin are calculated by solving for a theoretical loss equal to the acceptable loss in the price range [0, 3×Pr]. If a solution is found for a price point lower than Pr, the PoR can be referred to as “bearish,” and if the PoR is greater than Pr, then the PoR can be referred to as “bullish.”

It should be noted that while the range of motion module 116, the portfolio history determination module 118, the economic value of the tail module 120, the exposure determination module 122, and the points of ruin module 124 have been described with some specificity, these modules are provided by way of example only and are not meant to be restrictive of the present disclosure. Thus, in other embodiments, modules facilitating different functionality can be provided. For example, in some embodiments the system 100 provides functionality to determine a value at risk (VAR) (e.g., a conditional VAR) and/or an expected tail loss (e.g., an expected shortfall) associated with one or more investments. The system 100 is configured to provide VAR and/or expected tail loss information to a user 108 via the user interface 106. Further, systems 100 can chart returns and/or equity associated with one or more investments. In some embodiments, a histogram is provided to represent information associated with one or more investments. A histogram can include analytic (e.g., predictive and/or historical) information associated with one or more investments. For example, a Gaussian distribution, a fitted distribution, and so forth can be provided with a histogram.

Further, the system 100 includes an alert module 126. In embodiments of the disclosure, the alert module 126 is configured to provide an alert to a user 108 when a condition (or set of conditions) is met for the user's portfolio. For example, an alert is generated when a price point is reached that causes a loss greater than or equal to an acceptable loss level (e.g., as determined by the points of ruin module 124). In some embodiments, an alert is provided to a user 108 in the form of an email. In other embodiments, an alert is provided to a user 108 in the form of a text message. However, these alerts are provided by way of example only and are not meant to limit the present disclosure. In other embodiments, different alerts are provided to a user 108. Further, multiple alerts can be provided to a user 108 when a condition is met for the user's portfolio (e.g., an email and a text message, and so forth).

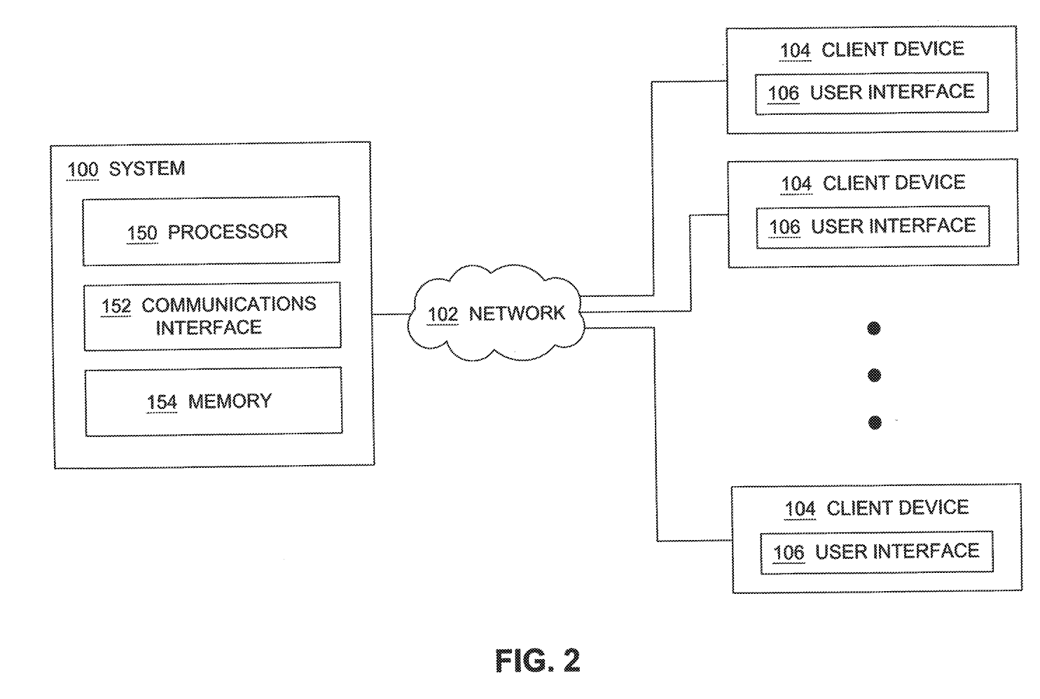

Referring to FIG. 2, a system 100, including some or all of its components, can operate under computer control. For example, a processor 150 can be included with or in a system 100 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

A processor 150 provides processing functionality for the system 100 and can include any number of processors, micro-controllers, or other processing systems, and resident or external memory for storing data and other information accessed or generated by the system 100. The processor 150 can execute one or more software programs that implement techniques described herein. The processor 150 is not limited by the materials from which it is formed or the processing mechanisms employed therein and, as such, can be implemented via semiconductor(s) and/or transistors (e.g., using electronic integrated circuit (IC) components), and so forth.

The system 100 includes a communications interface 152. The communications interface 152 is operatively configured to communicate with components of the system 100. For example, the communications interface 152 can be configured to transmit data for storage in the system 100, retrieve data from storage in the system 100, and so forth. The communications interface 152 is also communicatively coupled with the processor 150 to facilitate data transfer between components of the system 100 and the processor 150 (e.g., for communicating inputs to the processor 150 received from a device communicatively coupled with the system 100). It should be noted that while the communications interface 152 is described as a component of a system 100, one or more components of the communications interface 152 can be implemented as external components communicatively coupled to the system 100 via a wired and/or wireless connection. The system 100 can also comprise and/or connect to one or more input/output (I/O) devices (e.g., via the communications interface 152) including, but not necessarily limited to: a display, a mouse, a touchpad, a keyboard, and so on.

The communications interface 152 and/or the processor 150 can be configured to communicate with a variety of different networks including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to be restrictive of the present disclosure. Further, the communications interface 152 can be configured to communicate with a single network or multiple networks across different access points.

The system 100 also includes a memory 154. The memory 154 is an example of tangible, computer-readable storage medium that provides storage functionality to store various data associated with operation of the system 100, such as software programs and/or code segments, or other data to instruct the processor 150, and possibly other components of the system 100, to perform the functionality described herein. Thus, the memory 154 can store data, such as a program of instructions for operating the system 100 (including its components), and so forth. It should be noted that while a single memory 154 is described, a wide variety of types and combinations of memory (e.g., tangible, non-transitory memory) can be employed. The memory 154 can be integral with the processor 150, can comprise stand-alone memory, or can be a combination of both. The memory 154 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 154 can include removable integrated circuit card (ICC) memory, such as memory provided by a subscriber identity module (SIM) card, a universal subscriber identity module (USIM) card, a universal integrated circuit card (UICC), and so on.

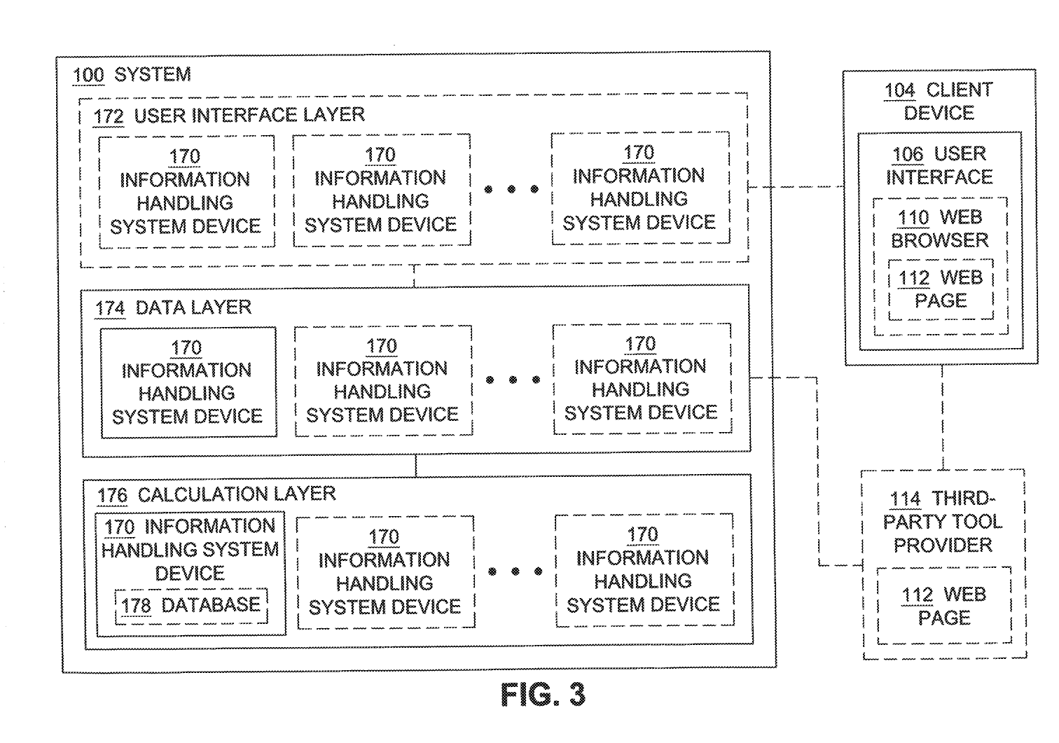

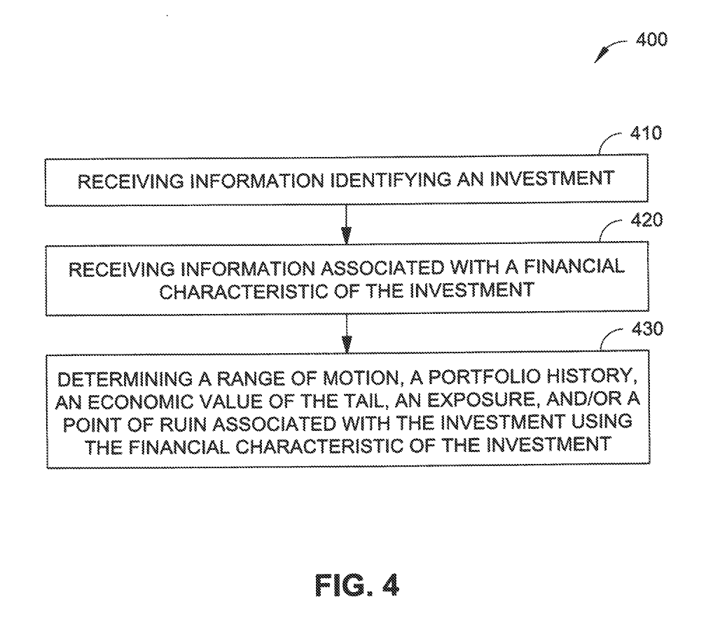

Referring now to FIGS. 3 and 4, a system 100 includes a number of information handling system devices 170. Further, a procedure 400 is described in an example implementation in which the system 100 is used to analyze a portfolio of investments. One or more of the information handling system devices 170 is implemented as a computing device that responds to requests across a computer network. For example, an information handling system device 170 is configured as a server (e.g., in a client-server architecture with a number of servers arranged in parallel). In this example, an information handling system device 170 receives a request from a client device 104 and/or a third-party tool provider 114 and serves information to the client device 104 and/or third-party tool provider 114 in response to the request. The information handling system devices 170 can also communicate with one another to serve the request. In some embodiments, the information handling system devices 170 are arranged in clusters, where each cluster provides functionality of the system 100. In embodiments of the disclosure, the system 100 provides functionality to balance the loads on the various clusters.

In some embodiments, a first cluster of information handling system devices 170 is configured as a user interface layer 172, a second cluster of information handling system devices 170 is configured as a data layer 174, and a third cluster of information handling system devices 170 is configured as a calculation layer 176. The user interface layer 172 can be configured as a web layer that provides client-side script (e.g., JavaScript (JS)) configured to allow a user 108 to interact with content provided by the system 100 (e.g., in the form of a web page 112). For example, a web browser 110 is configured to receive input from a user 108 identifying an investment (e.g., an investment portfolio represented by stock symbols and associated quantities) (Block 410). The portfolio information is transferred from the client device 106 to the user interface layer 172, and then to the data layer 174. The data layer 174 is configured to authenticate the user 108, verify the symbols provided, and so forth. However, this example is not meant to limit the present disclosure. In other embodiments, the data layer 174 communicates directly with a third-party tool provider 114 (e.g., using an application programming interface (API) or the like). The portfolio information is then transferred from the data layer 174 to the calculation layer 176.

The calculation layer 176 is configured to implement one or more of the range of motion module 116, the portfolio history determination module 118, the economic value of the tail module 120, the exposure determination module 122, the points of ruin module 124, and so forth. For example, the calculation layer 176 includes a database 178 (e.g., an in-memory database, a relational database (e.g., a structure query language (SQL) server), and so forth). The calculation layer 176 accesses the database 178 to obtain information associated with one or more financial characteristics of the investment (Block 420). In embodiments of the disclosure, the database 178 includes information collected from market data. For example, the database 178 stores market information, including but not necessarily limited to: historical pricing information, historical return information, current pricing information, current return information, and so forth. In some embodiments, the calculation layer 176 receives market data information from a market data source (e.g., a third-party) and builds historical return information to be stored in the database 178 (e.g., by batch processing and/or real-time processing of financial market data at the end of a day, throughout a day, and so forth). As described, the calculation layer 176 determines one or more of a range of motion, a portfolio history, an economic value of the tail, an exposure, points of ruin, and so forth (Block 430). The calculation layer 176 then transfers this information to the data layer 174, which, in turn, transfers the information to the client device 104 (e.g., via the user interface layer 172) and/or to the third-party tool provider 114.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system or circuit. Further, elements of the blocks, systems, or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A portfolio analysis system comprising:
a memory operable to store one or more modules; and
a processor operably coupled to the memory, the processor operable to execute the one or more modules to:
receive information identifying at least one investment,
receive information associated with at least one financial characteristic of the at least one investment,
determine at least one of a range of motion, a portfolio history, an economic value of the tail, an exposure, or a point of ruin associated with the at least one investment using the information associated with the at least one financial characteristic of the at least one investment, and
initiate an alert when at least one condition is met for the at least one investment based upon the determination of the at least one of the range of motion, the portfolio history, the economic value of the tail, the exposure, or the point of ruin.

2. The portfolio analysis system as recited in claim 1, wherein the processor is operable to execute the one or more modules to:
receive information identifying an alteration of the at least one investment,
receive information associated with at least one financial characteristic of the altered at least one investment; and
determine at least one of a second range of motion, a second portfolio history, a second economic value of the tail, a second exposure, or a second point of ruin associated with the altered at least one investment using the information associated with the at least one financial characteristic of the altered at least one investment.

3. The portfolio analysis system as recited in claim 1, wherein the range of motion is determined by a one-period log-return cumulative probability distribution of X, where ƒ(X) is a probability density function of X, and the one-period log-return cumulative probability distribution is defined by a mean and two dispersion parameters.

4. The portfolio analysis system as recited in claim 1, wherein the portfolio history is determined by a vector time series of synthetic log-returns based upon a historical price of a security and a historical price of an underlying security of at least one of a derivative or an option.

5. The portfolio analysis system as recited in claim 1, wherein the economic value of the tail is determined by a vector time series of a number of one-period log-returns for a financial security.

6. The portfolio analysis system as recited in claim 1, wherein the exposure is determined for a current market price Pr by dividing a line between Pr·exp(RD(α)) and Pr·exp(RU(α)) into a plurality of equally-spaced prices, where RU(α) denotes an upper bound of the range of motion, and RD(α) denotes a lower bound of the range of motion.

7. The portfolio analysis system as recited in claim 1, wherein the points of ruin is determined at a group of directly related holdings level using a closest price point from a current price, which, if reached, would cause a theoretical loss greater than or equal to an acceptable loss.

8. A portfolio analysis system comprising:
a memory operable to store one or more modules and information associated with at least one financial characteristic of at least one investment; and
a processor operably coupled to the memory, the processor operable to execute the one or more modules to:
provide an interactive user interface configured to receive information identifying the at least one investment,
retrieve the information associated with the at least one financial characteristic of the at least one investment from the memory,
determine at least one of a range of motion, a portfolio history, an economic value of the tail, an exposure, or a point of ruin associated with the at least one investment using the information associated with the at least one financial characteristic of the at least one investment,
receive information identifying an alteration of the at least one investment via the user interface,
retrieve information associated with at least one financial characteristic of the altered at least one investment from the memory; and
determine at least one of a second range of motion, a second portfolio history, a second economic value of the tail, a second exposure, or a second point of ruin associated with the altered at least one investment using the information associated with the at least one financial characteristic of the altered at least one investment.

9. The portfolio analysis system as recited in claim 8, wherein the processor is operable to execute the one or more modules to initiate an alert when at least one condition is met for the at least one investment based upon the determination of the at least one of the range of motion, the portfolio history, the economic value of the tail, the exposure, the point of ruin, the second range of motion, the second portfolio history, the second economic value of the tail, the second exposure, or the second point of ruin.

10. The portfolio analysis system as recited in claim 8, wherein the range of motion is determined by a one-period log-return cumulative probability distribution of X, where ƒ(X) is a probability density function of X, and the one-period log-return cumulative probability distribution is defined by a mean and two dispersion parameters.

11. The portfolio analysis system as recited in claim 8, wherein the portfolio history is determined by a vector time series of synthetic log-returns based upon a historical price of a security and a historical price of an underlying security of at least one of a derivative or an option.

12. The portfolio analysis system as recited in claim 8, wherein the economic value of the tail is determined by a vector time series of a number of one-period log-returns for a financial security.

13. The portfolio analysis system as recited in claim 8, wherein the exposure is determined for a current market price Pr by dividing a line between Pr·exp(RD(α)) and Pr·exp(RU(α)) into a plurality of equally-spaced prices, where RU(α) denotes an upper bound of the range of motion, and RD(α) denotes a lower bound of the range of motion.

14. The portfolio analysis system as recited in claim 8, wherein the points of ruin is determined at a group of directly related holdings level using a closest price point from a current price, which, if reached, would cause a theoretical loss greater than or equal to an acceptable loss.

15. A portfolio analysis system comprising:
a memory operable to store one or more modules; and
a processor operably coupled to the memory, the processor operable to execute the one or more modules to:
receive information identifying at least one investment,
receive information associated with at least one financial characteristic of the at least one investment,
determine a range of motion associated with the at least one investment using the information associated with the at least one financial characteristic of the at least one investment, wherein the range of motion is determined by a one-period log-return cumulative probability distribution of X, where ƒ(X) is a probability density function of X, and the one-period log-return cumulative probability distribution is defined by a mean and two dispersion parameters.

16. The portfolio analysis system as recited in claim 15, wherein the processor is operable to execute the one or more modules to initiate an alert when at least one condition is met for the at least one investment based upon the determination of the range of motion.

17. The portfolio analysis system as recited in claim 15, wherein the processor is operable to execute the one or more modules to determine a portfolio history, the portfolio history determined by a vector time series of synthetic log-returns based upon a historical price of a security and a historical price of an underlying security of at least one of a derivative or an option.

18. The portfolio analysis system as recited in claim 15, wherein the processor is operable to execute the one or more modules to determine an economic value of the tail, the economic value of the tail determined by a vector time series of a number of one-period log-returns for a financial security.

19. The portfolio analysis system as recited in claim 15, wherein the processor is operable to execute the one or more modules to determine an exposure, the exposure determined for a current market price Pr by dividing a line between Pr·exp(RD(α)) and Pr·exp(RU(α)) into a plurality of equally-spaced prices, where RU(α) denotes an upper bound of the range of motion, and RD(α) denotes a lower bound of the range of motion.

20. The portfolio analysis system as recited in claim 15, wherein the processor is operable to execute the one or more modules to determine points of ruin, the points of ruin determined at a group of directly related holdings level using a closest price point from a current price, which, if reached, would cause a theoretical loss greater than or equal to an acceptable loss.
